(19) United States
(12) Patent Application Publication
(10) Pub. No.: US 2006/0055335 A1
(43) Pub. Date: Mar. 16, 2006

(54) Organic-electroluminescence display and driving method therefor

(76) Inventors: Akira Shingai, Kokubunji (JP); Masahito Fujihira, Ichihara (JP); Naoki Tokuda, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/196,268

(22) Filed: Aug. 4, 2005

(30) Foreign Application Priority Data
Aug. 4, 2004 (JP) 2004-227701

(51) Int. Cl. G09G 3/10

(52) U.S. Cl. 315/169.3

(57) ABSTRACT

In a method of driving an organic-electroluminescence display device, when a small white pattern is displayed at the same position of the black background for a long time, burn-in of the white-pattern displayed portion is prevented without a feeling of a sense of the contrast lack. The organic-electroluminescence display device includes an organic-electroluminescence element panel, and an input-signal processing circuit into which an image signal is to be input. The input-signal processing circuit includes a luminance detection circuit for detecting average luminance of the input image signal, and a luminance control circuit. The luminance control circuit, when, as an image on the organic-electroluminescence element panel, a high-luminance pattern continues to be displayed longer than a time-interval T1 on a low average-luminance screen, lowers the luminance of the pattern down to a predetermined value with a time-interval T2 after T1.

### INCORPORATION BY REFERENCE

The present application claims priority from Japanese application JP2004-227701 filed on Aug. 4, 2004, the content of which is hereby incorporated by reference into this application.

### BACKGROUND OF THE INVENTION

1. Field of the Invention

The present invention relates to an organic-electroluminescence display device using organic-electroluminescence (EL; Electro Luminescence) elements, and a driving method therefor. More particularly, it relates to a technology for preventing burn-in at the time of displaying a small white pattern at the same position of the black background for a long time.

2. Description of the Related Art

An active-matrix-driven organic-electroluminescence display device (which, hereinafter, will be referred to as “organic-EL display”) using organic-electroluminescence elements (hereinafter, referred to as “organic-EL elements”) is expected as the next-generation flat panel display.

As described in, e.g., JP-A-2002-189445, in a typical organic-EL display, a plurality of pixels are arranged in a matrix-like manner. Each pixel includes an organic-EL element, a driving transistor connected to the organic-EL element in series therewith, and a capacitor for holding the gate voltage of this driving transistor.

The organic-EL element has the following structure: A light-emitting layer, which is a thin film including a red, green, or blue fluorescent organic compound, is sandwiched between a cathode electrode and an anode electrode. Here, electrons and positive holes are injected into the light-emitting layer. This rebinds the electrons and the positive holes, thereby generating excitons. Light emission which occurs at activation-lost time of these excitons allows the light-emitting layer and the organic-EL element to emit the light.

Meanwhile, as described in, e.g., JP-A-2001-27890 (and its corresponding European Patent Publication EP1111578A1), it has been known that, in a liquid-crystal television and the like, the use of image processing technology allows implementation of high picture quality.

### SUMMARY OF THE INVENTION

In the organic-EL display device as described above, if a small white pattern is displayed at the same position of the black background for a long time, the white-pattern displayed portion will be burned in. In order to solve this problem, it is effective enough to lower the luminance of the white pattern displayed against the black background. In this case, however, there has existed a problem that the contrast will be lowered.

The present invention has been devised in order to solve the above-described problem in the prior art. Accordingly, an object of the present invention is to provide the following technology in the organic-EL display device and the driving method therefor: Namely, a technology for allowing prevention of the burn-in of the white-pattern displayed portion without a feeling of a sense of the contrast lack when the small white pattern is displayed at the same position of the black background for a long time.

The above-described and the other objects and novel characteristics of the present invention will be made apparent by the description of the present specification and the accompanying drawings.

Of inventions to be disclosed in the present application, outline of the representative invention will be briefly explained as follows:

In order to accomplish the above-described object, in the present invention, when, as an image displayed on the organic-electroluminescence element panel, a high-luminance fixed pattern continues to be displayed longer than a time-interval T1 (e.g., 10 seconds) on a low average-luminance screen, the luminance of the fixed pattern for example is controlled to be lowered from 100% to a predetermined value, e.g., 80%, with a time-interval T2 (e.g., 3 seconds) after T1.

If the luminance of the high-luminance and small-area portion is lowered to 80% from the beginning, the contrast is lowered. This results in a lowering in picture quality. In the present invention, however, the portion is displayed with the 100-% luminance at the beginning. This condition prevents the contrast from being lowered. Next, the luminance is lowered in a little-by-little manner with the time spent. This condition prevents the feeling of a sense of the contrast lack unlike the case where the 80-% luminance is displayed from the beginning.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram for illustrating the schematic configuration of an organic-EL display device in an embodiment of the present invention;

FIG. 2 is a diagram for illustrating an equivalence circuit to the organic-EL display panel illustrated in FIG. 1 together with a data driver and a scanning-line driving circuit;

FIG. 3A to FIG. 3D are diagrams for illustrating an example of the image signal processing on the periphery of a picture-quality control circuit of the organic-EL display according to the present invention;

FIG. 4A to FIG. 4D are diagrams for illustrating an example of the image signal processing on the periphery of the picture-quality control circuit of the organic-EL display device according to the present invention;

FIG. 5A to FIG. 5C are schematic diagrams for explaining the driving method of the organic-EL display in the embodiment of the present invention;

FIG. 6A to FIG. 6C are schematic diagrams for explaining a modified example of the driving method of the organic-EL display device in the embodiment of the present invention;

FIG. 7A to FIG. 7B are schematic diagrams for explaining a modified example of the driving method of the organic-EL display device in the embodiment of the present invention;

FIG. 8A to FIG. 8C are schematic diagrams for explaining a modified example of the driving method of the organic-EL display device in the embodiment of the present invention;

FIG. 9A to FIG. 9C are schematic diagrams for explaining a modified example of the driving method of the organic-EL display device in the embodiment of the present invention;

FIG. 10A to FIG. 10B are schematic diagrams for explaining a modified example of the driving method of the organic-EL display device in the embodiment of the present invention;

FIG. 11 is a circuit diagram for illustrating another example of one pixel of the organic-EL display panel illustrated in FIG. 2; and

FIG. 12 is a circuit diagram for illustrating another example of one pixel of the organic-EL display panel illustrated in FIG. 2.

### DETAILED DESCRIPTION OF THE INVENTION

Hereinafter, referring to the drawings, the detailed explanation will be given below concerning embodiments of the present invention.

Incidentally, in all of the drawings for explaining the embodiments, one and the same reference numeral is allocated to a configuration component having one and the same function. Accordingly, the repeated explanation thereof will be omitted.

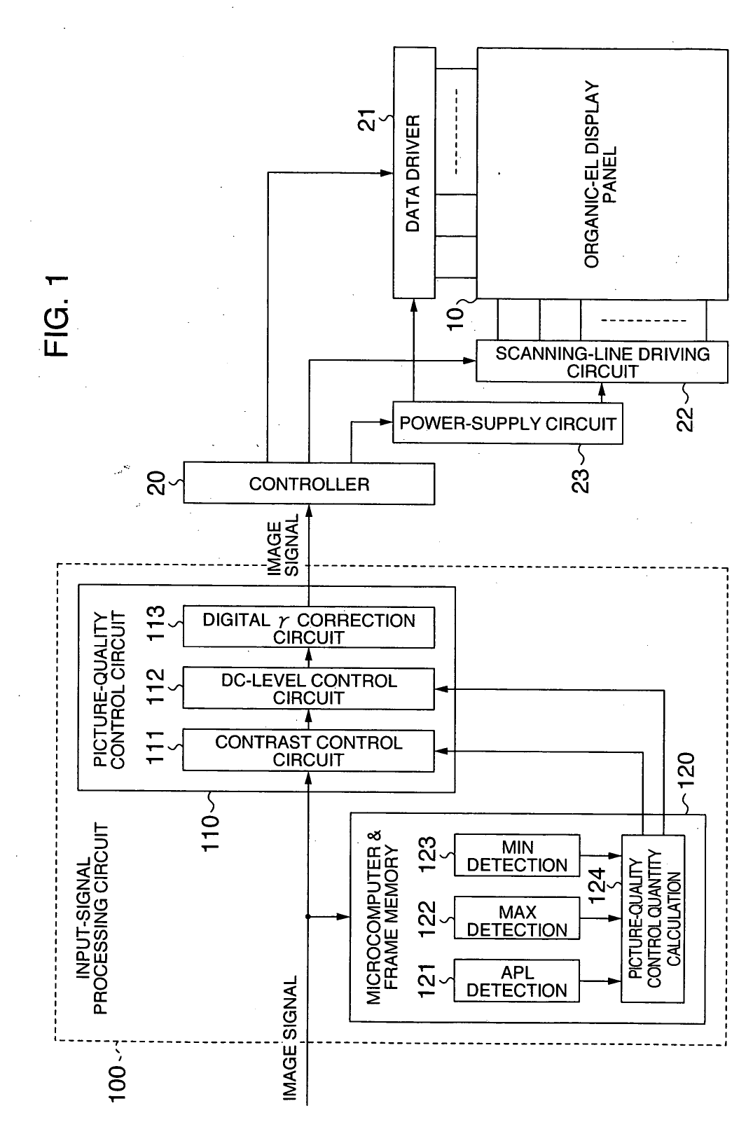

FIG. 1 is a block diagram for illustrating the schematic configuration of an organic-EL display device in an embodiment of the present invention.

The organic-EL display device of the present invention includes the following configuration components: An organic-EL display panel 10, a data driver 21 and a scanning-line driving circuit 22 located or formed on the periphery thereof, a controller 20 for controlling the data driver 21 and the scanning-line driving circuit 22, and an input-signal processing circuit 100. Here, in the input-signal processing circuit 100, an image signal inputted from an external circuit of the organic-EL display is transmitted to the controller 20 after being processed such that the image signal is made compatible with image display on the organic-EL display panel 10.

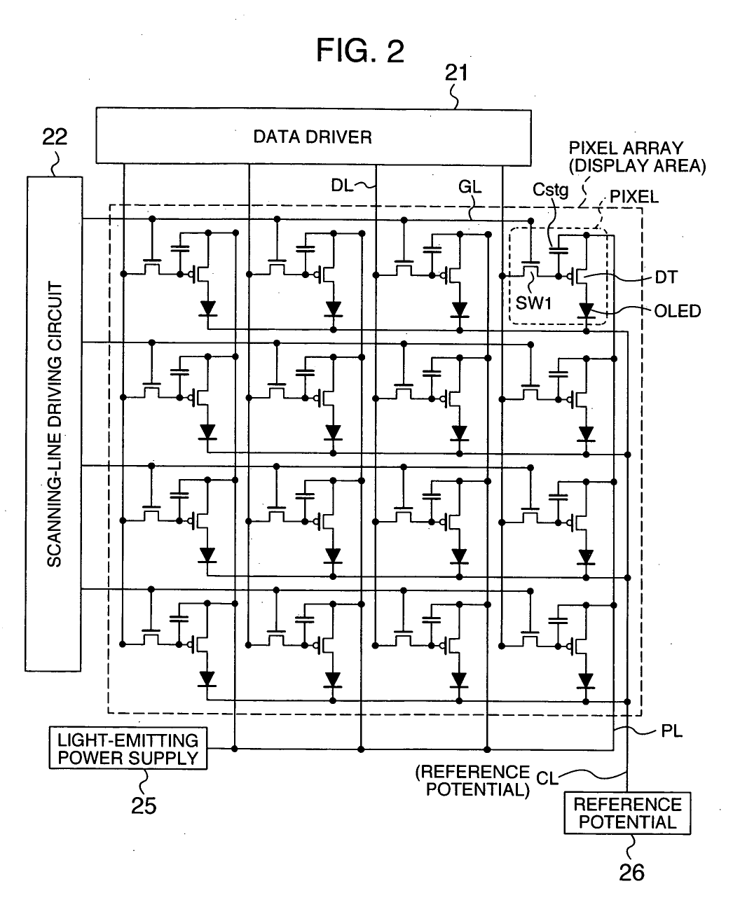

FIG. 2 is a diagram for illustrating an equivalence circuit to the organic-EL display panel 10 illustrated in FIG. 1 together with the data driver 21 and the scanning-line driving circuit 22.

In FIG. 2, each switching-use thin film transistor (SW1) is an n-type thin film transistor. Its gate, source, and drain are connected to each scanning line (GL), each image line (DL), and the gate of each driving-use thin film transistor (DT), respectively.

Also, each driving-use thin film transistor (DT) is a p-type thin film transistor. Its source and drain are connected to each power-supply line (PL) and the anode of each organic-EL element (OLED), respectively.

Also, each charge storage capacitor (Cstg) is connected to between the gate of each driving-use thin film transistor (DT) and each power-supply line (PL).

Each scanning line (GL) is connected to the scanning-line driving circuit 22. Each image line (DL) illustrated in FIG. 2 is connected to the data driver 21 illustrated in FIG. 1. The data driver 21 supplies an analogue image signal to each image line (DL).

The scanning-line driving circuit 22 supplies a scanning-line selection signal to the respective scanning lines (GL) in sequence in each frame time-interval.

The switching-use thin film transistors (SW1) in each row are brought into conduction only during one horizontal scanning time-interval by the scanning-line selection signal supplied from each corresponding scanning line (GL). Then, the transistors (SW1) are brought into non-conduction until the scanning-line selection signal is supplied again one frame time-interval after.

Based on the conduction of each switching-use thin film transistor (SW1), the analogue image signal supplied from each image line (DL) is written into each charge storage capacitor (Cstg), then being updated on one frame time-interval (1F) (i.e., updating period) basis.

Each driving-use thin film transistor (DT) for one pixel supplies, to each organic-EL element (OLED), a driving current (Id) corresponding to the analogue image signal written into each charge storage capacitor (Cstg). This allows each organic-EL element (OLED) to emit light. Incidentally, in FIG. 2, a numeral 25 denotes a light-emitting power supply, and a numeral 26 denotes a reference potential (e.g., GND).

Each organic-EL element (OLED) has the following structure: A light-emitting layer, which is a thin film including a fluorescent organic compound, is sandwiched between a cathode electrode and an anode electrode. Here, electrons and positive holes are injected into the light-emitting layer. This rebinds the electrons and the positive holes, thereby generating excitons. Light emission which occurs at activation-lost time of these excitons allows each organic-EL element to emit the light.

Each switching-use thin film transistor (SW1) and each driving-use thin film transistor (DT) include, e.g., a thin film transistor where a polycrystalline silicon film is used as the semiconductor layer.

Also, the scanning-line driving circuit 22 and the data driver 21 are formed at the same processing step as that of each switching-use thin film transistor (SW1) and each driving-use thin film transistor (DT). Moreover, the scanning-line driving circuit 22 and the data driver 21, which include N-channel thin film transistors or P-channel thin film transistors where polycrystalline silicon films are used as the semiconductor layers, are integrally formed on one and the same insulating board.

Here, the scanning-line driving circuit 22 and the data driver 21 are controlled and driven by the controller 20. Also, a power-supply circuit 23 supplies, to the scanning-line driving circuit 22 and the data driver 21, power-supply voltage, or organic-EL element (OLED) driving voltage (e.g., tone voltage, scanning-line selection voltage, scanning-line non-selection voltage, or the like).

The input-signal processing circuit 100 illustrated in FIG. 1 includes a picture-quality control circuit 110 and a microcomputer & frame memory 120. The picture-quality control circuit 110 includes, from its input side, a contrast control circuit 111, a DC-level control circuit 112, and a digital γ correction circuit 113. An image signal outputted from the digital γ correction circuit 113 is transferred to the controller 20.

The image signal outputted from an image-signal output terminal of an external circuit (not illustrated) such as television set, video camera, or mobile telephone is inputted not only into the contrast control circuit 111 from the input side of the picture-quality control circuit 110, but also into the microcomputer & frame memory 120.

The microcomputer & frame memory 120 receives the image signal from the external circuit, then, based on this image signal, analyzing characteristics of an image to be displayed on the organic-EL display panel 10.

Concretely, an APL detection unit 121, a MAX detection unit 122, and a MIN detection unit 123 detect average luminance level of the image signal inputted (hereinafter, designated as “APL”), maximum luminance level (hereinafter, designated as “MAX”) thereof, and minimum luminance level (hereinafter, designated as “MIN”) thereof, respectively.

The detection of these maximum luminance level MAX, minimum luminance level MIN, and average luminance level APL is the processing performed from conventionally. Accordingly, the detailed explanation thereof will be omitted here.

For example, when a screen on the organic-EL display panel 10 displays a plurality of bright “points” scattered against the dark background, such as “starry sky”, the average luminance level APL of the image signal corresponding to this screen appears on the darker side than the intermediate point between its maximum luminance level MAX and its minimum luminance level MIN.

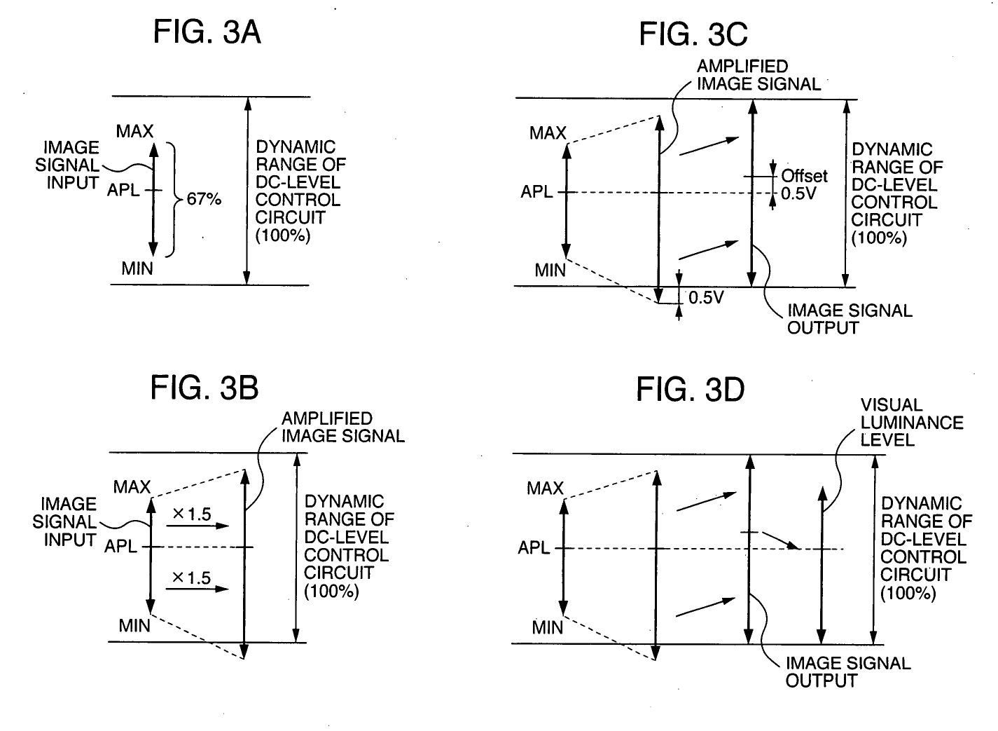

The maximum luminance level MAX, minimum luminance level MIN, and average luminance level APL of the inputted image signal detected in the respective detection units are inputted into a picture-quality control quantity calculation unit 124, where the picture-quality control quantity will be calculated. Its concrete example will be described later, referring to FIG. 2 and FIG. 3.

The microcomputer & frame memory 120 transfers, as a picture-quality control signal, a calculation result of the picture-quality control quantity to the contrast control circuit 111 and the DC-level control circuit 112 of the picture-quality control circuit 110.

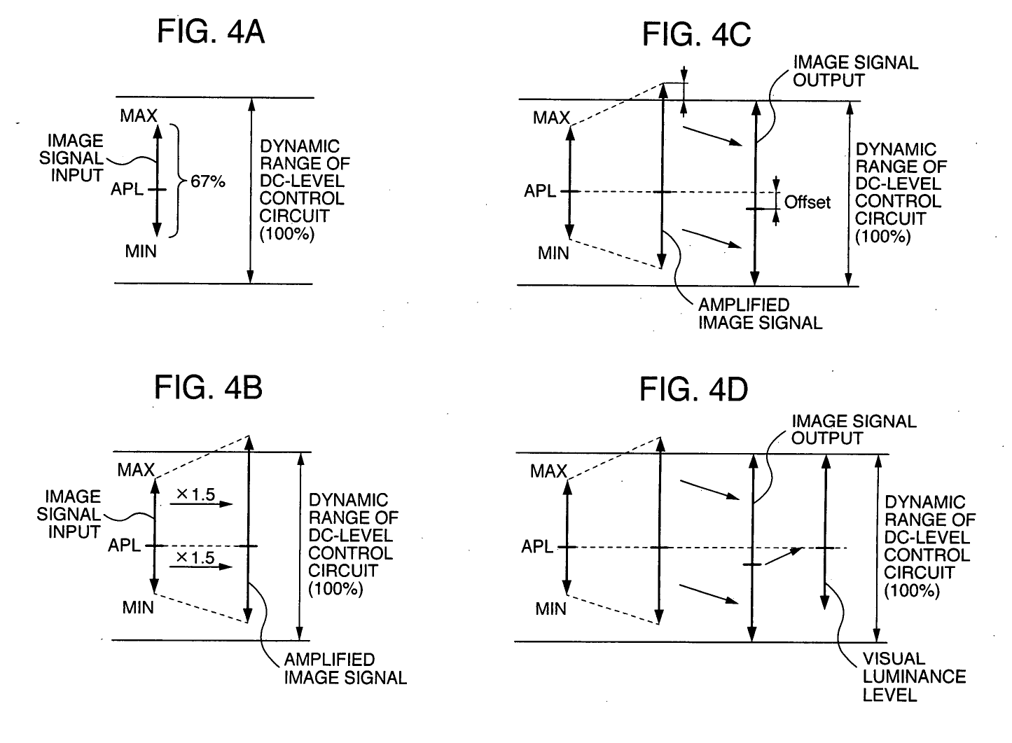

FIG. 3A to FIG. 3D and FIG. 4A to FIG. 4D are diagrams for illustrating one examples of the processing for the image signal on the periphery of the picture-quality control circuit 110 (so to speak, “interface” which is positioned on the external-circuit-nearer side than the controller 20).

As will be explained below, both of the signal processing ranging from FIG. 3A to FIG. 3D and the signal processing ranging from FIG. 4A to FIG. 4D will be performed in a similar way. What is different therebetween, however, is the value of the average luminance level APL with respect to the intermediate value between the maximum luminance level MAX and the minimum luminance level MIN inputted from the respective detection units (121, 122, and 123) into the picture-quality control quantity calculation unit 124.

In the former signal processing, as illustrated in FIG. 3A, an image signal from the external circuit exhibits the average luminance level APL which is larger than the intermediate value. Consequently, this image signal corresponds to an image which makes the screen on the organic-EL display panel bright as a whole (e.g., beach on fine-weather day).

In the latter signal processing, as illustrated in FIG. 4A, an image signal from the external circuit exhibits the average luminance level APL which is smaller than the intermediate value. Consequently, this image signal corresponds to an image which makes the screen on the organic-EL display panel dark as a whole (e.g., starry sky).

Next, referring to FIG. 3A to FIG. 3D and FIG. 4A to FIG. 4D, the explanation will be given below concerning the signal processing in the interface of the organic-EL display in the present embodiment.

First, the maximum luminance level MAX, the minimum luminance level MIN, and the average luminance level APL of the image signal in a certain frame time-interval are inputted into the picture-quality control quantity calculation unit 124 from the respective detection units (121, 122, and 123).

As compared with output dynamic range (i.e., maximum value of amplitude that output signal can assume) of the DC-level control circuit 112 included in the picture-quality control circuit 110, if maximum amplitude (i.e., difference between the maximum luminance level MAX and the minimum luminance level MIN) of the image signal in the above-described certain frame time-interval is smaller, at a point-in-time at which the image signal is outputted from the DC-level control circuit 112 (in this case, the image signal is then inputted into the digital y correction circuit 113), the image signal is amplified so that the image signal will have an amplitude which is substantially equal to the output dynamic range of the DC-level control circuit 112.

In the contrast control circuit 111 of the picture-quality control circuit 110, the amplification of the image signal as described above is subjected to the image signal inputted therein from the external circuit.

Meanwhile, the microcomputer & frame memory 120 determines the maximum amplitude of the image signal from the difference between the maximum luminance level MAX thereof and the minimum luminance level MIN thereof. Moreover, the microcomputer & frame memory 120 compares this maximum amplitude with the output dynamic range of the DC-level control circuit 112, thereby determining amplification ratio of the image signal (i.e., signal-amplification adjustment gain: Gain) in the contrast control circuit 111 by using the following Expression (1):
Gain=dynamic range/(MAX−MIN) (1)

For example, the difference between the maximum luminance level MAX and the minimum luminance level MIN of the image signal illustrated in FIG. 3A and FIG. 4A is equal to 67% of width of the output dynamic range (which is displayed as being 100%) of the DC-level control circuit 112. Accordingly, the microcomputer & frame memory 120 calculates the Gain of about 1.5. The Gain calculated by the microcomputer & frame memory 120 is transferred to the contrast control circuit 111, where the amplification ratio of the image signal based thereon is determined.

By the way, as illustrated in FIG. 3A and FIG. 4A, in many cases, the minimum luminance level MIN of the image signal from the external circuit differs from lower-limit of the output signal of the DC-level control circuit 112. Also, in many cases, the maximum luminance level MAX of the image signal from the external circuit differs from upper-limit of the output signal of the DC-level control circuit 112.

On account of this, as illustrated in FIG. 3B and FIG. 4B, the amplification of the image signal is subjected to the image signal with its average luminance level APL selected as the criterion (with DC-level of the APL fixed). In this case, however, the following phenomenon occurs: Namely, the minimum luminance level MIN of the image signal amplified (hereinafter, referred to as “amplified image signal”) becomes smaller than the lower-limit of the output signal of the DC-level control circuit 112 (FIG. 3B). Also, the maximum luminance level MAX of the amplified image signal becomes larger than the upper-limit of the output signal of the DC-level control circuit 112 (FIG. 4B).

In order to deal with the problem like this, the contrast control circuit 111 is designed as follows: Namely, the circuit 111 has an output dynamic range which is sufficiently wider than that of the DC-level control circuit 112. Simultaneously, as illustrated in FIG. 3C, the circuit 111 outputs, as “a negative signal”, the part (e.g., 0.5 V) of the amplified image signal which has exceeded the lower-limit of the output dynamic range of the DC-level control circuit 112.

The DC-level control circuit 112 receives the amplified image signal outputted from the contrast control circuit 111 in this way, then adjusting DC level of the amplified image signal (FIG. 3C and FIG. 4C). This DC-level adjustment of the amplified image signal causes oscillation range of the amplified image signal to fall within the output dynamic range of the DC-level control circuit 112.

The DC-level adjustment quantity of the amplified image signal is also designated as “the picture-quality control quantity”, or as “DC-level shift quantity”. In the present specification, hereinafter, the DC-level adjustment quantity will also be designated as merely “Offset”. This Offset is calculated by the microcomputer & frame memory 120, then being inputted into the DC-level control circuit 112.

The amplified image signal whose DC-level has been shifted by the DC-level control circuit 112 is illustrated as “image signal output” in each of FIG. 3C and FIG. 4C. This image signal output is inputted into the controller 20 via the digital γ correction circuit 113.

The controller 20 makes reference to the image signal output from the picture-quality control circuit 110 (digital γ correction circuit 113), then adjusting current quantity (which is supplied to each organic-EL element of each pixel) along each power-supply line (PL) on the organic-EL display panel 10, or adjusting a tone signal for determining data signal output in the data driver 21.

Both of the adjustments are performed such that the average luminance level APL of a displayed image on each frame time-interval basis is made equal to the average luminance level APL at the time of input of the image signal corresponding thereto. This makes it possible to suppress a variation in the average luminance level APL of the image signal output illustrated in each of FIG. 3C and FIG. 4C. Consequently, as is indicated as “visual luminance level” in each of FIG. 3D and FIG. 4D, dynamic range of the luminance in the displayed image varies depending on entire brightness of the displayed image.

In general, in an organic-EL display, if a small white pattern is displayed at the same position of the black background for a long time, the white-pattern displayed portion will be burned in. In order to solve this problem, it is effective enough to lower the luminance of the white pattern displayed against the black background. In this case, however, there has existed a problem that the contrast will be lowered.

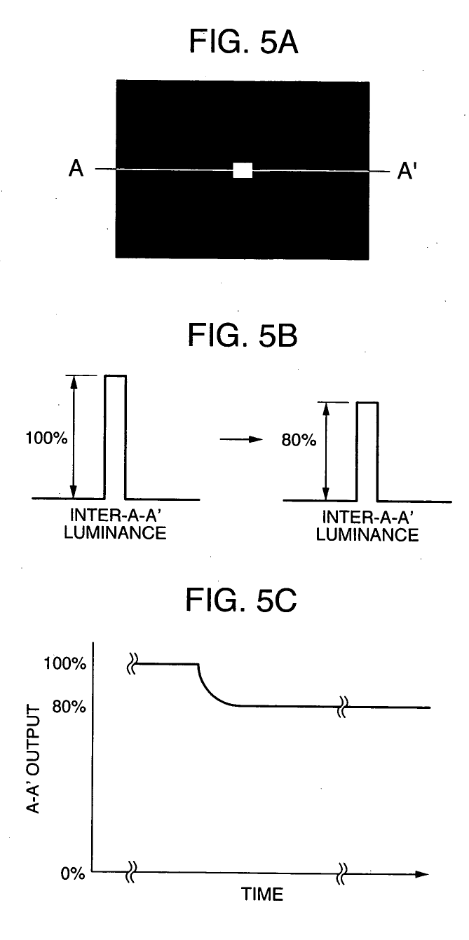

FIG. 5A to FIG. 5C are schematic diagrams for explaining the driving method of the organic-EL display in the present embodiment.

In the organic-EL display in the present embodiment, as illustrated in FIG. 5A, a high-luminance, small white pattern is displayed on a low average-luminance screen (here, black). Here, when letting luminance of the black background be 0%, the luminance of the white pattern is set as being 100%.

In the driving method illustrated in FIG. 5A to FIG. 5C, as illustrated in FIG. 5B, when the high-luminance, small white pattern continues to be displayed longer than a time-interval T1 (here, 10 seconds) at the same position of the black background, the luminance of the fixed pattern will be lowered from 100% to about 80% with about a time-interval T2 (here, 3 seconds) spent.

In this case, as illustrated in FIG. 5C, the lowering of the high-luminance, small white pattern from the 100-% luminance to the 80-% luminance is performed within the time-interval T2 in a curve-like manner such that the former-half portion changes steeply and the latter-half portion changes gradually.

On account of this, in the present embodiment, it becomes possible to prevent the burn-in of the white-pattern displayed portion without a feeling of a sense of the contrast lack when the small white pattern is displayed at the same position of the black background for a long time.

In general, if the luminance of the high-luminance and small-area portion is lowered to 80% from the beginning, the contrast is lowered. This results in a lowering in the picture quality. In the present embodiment, however, the portion is displayed with the 100-% luminance at the beginning. This prevents the contrast from being lowered. Next, the luminance is lowered in a little-by-little manner with the time spent. This prevents the feeling of a sense of the contrast lack unlike the case where the 80-% luminance is displayed from the beginning.

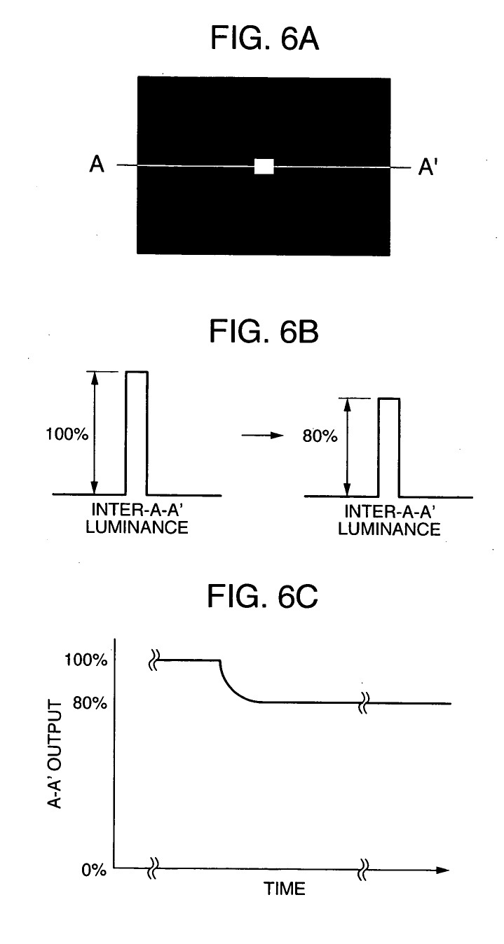

FIG. 6A to FIG. 6C are schematic diagrams for explaining a modified example of the driving method of the organic-EL display in the present embodiment.

In the case of FIG. 6A to FIG. 6C as well, as illustrated in FIG. 6A, a high-luminance, small white pattern is displayed on a low average-luminance screen (here, black). Here, when letting luminance of the black background be 0%, the luminance of the white pattern is set as being 100%.

In the driving method illustrated in FIG. 6A to FIG. 6C as well, as illustrated in FIG. 6B, when the high-luminance, small white pattern is displayed at the same position of the black background, if the display of the high-luminance portion continues to be performed longer than 10 seconds, the luminance will be lowered from 100% to about 80% with about 3 seconds spent.

In the driving method illustrated in FIG. 6A to FIG. 6C, however, the high-luminance portion whose luminance will be lowered to about 80% is displayed using FRC (Frame Rate Control) from luminance of 70% and luminance of 90%. Namely, 70% and 90% are displayed alternately, thereby making the luminance seemingly equal to 80% through the use of afterimage of human eyes.

Also, as illustrated in FIG. 6C, the lowering of the high-luminance, small white pattern from the 100-% luminance to the 80-% luminance is performed within the time-interval T2 in a curve-like manner such that the former-half portion changes steeply and the latter-half portion changes gradually.

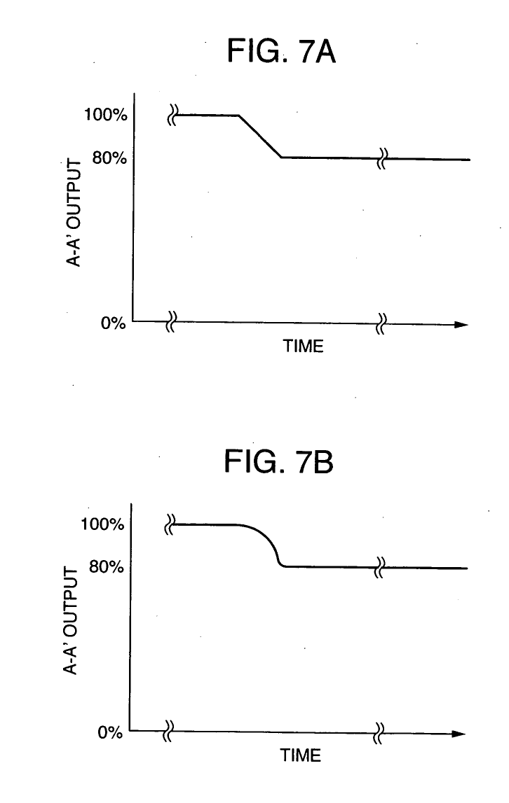

FIG. 7A to FIG. 7B are schematic diagrams for explaining a modified example of the driving method of the organic-EL display in the present embodiment.

In FIG. 5C and FIG. 6C, the lowering of the high-luminance, small white pattern from the 100-% luminance to the 80-% luminance is performed within the time-interval T2 in a curve-like manner such that the former-half portion changes steeply and the latter-half portion changes gradually. In FIG. 7A, however, the lowering of the high-luminance, small white pattern from the 100-% luminance to the 80-% luminance is performed in a straight-line-like manner (i.e., the luminance is decreased uniformly with respect to time).

Also, FIG. 7B illustrates the following configuration: Namely, the lowering of the high-luminance, small white pattern from the 100-% luminance to the 80-% luminance is performed in a curve-like manner which becomes opposite to a curve-like manner illustrated in FIG. 5C and FIG. 6C. This means that the lowering is performed within the time-interval T2 in a curve-like manner such that the former-half portion changes gradually and the latter-half portion changes steeply.

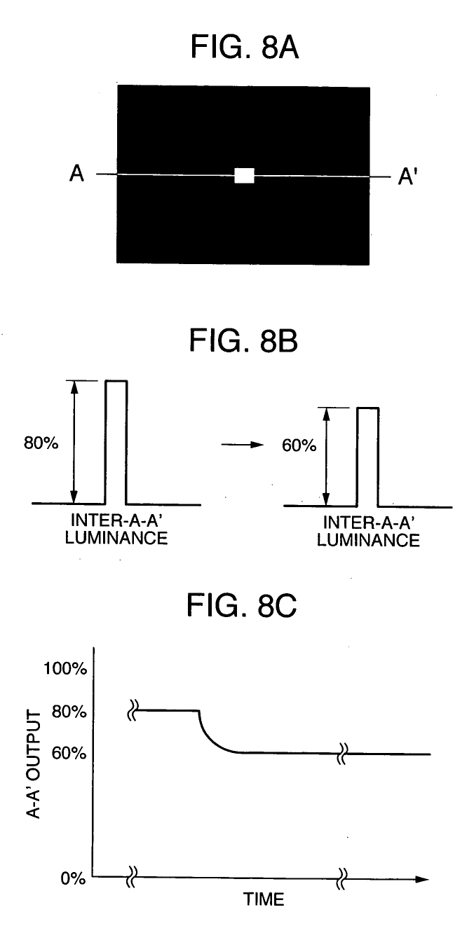

FIG. 8A to FIG. 8C are schematic diagrams for explaining a modified example of the driving method of the organic-EL display in the present embodiment.

In the driving method illustrated in FIG. 8A to FIG. 8C as well, as illustrated in FIG. 8A, a high-luminance, small white pattern is displayed on a low average-luminance screen (here, black). The driving method illustrated in FIG. 8A to FIG. 8C, however, differs from the above-described driving method illustrated in FIG. 5A to FIG. 5C in a point that, when letting luminance of the black background be 0%, the luminance of the white pattern is set as being 80%.

In the driving method illustrated in FIG. 8A to FIG. 8C, as illustrated in FIG. 8B, when the high-luminance, small white pattern is displayed against the black background, if the display of the high-luminance portion continues to be performed longer than 10 seconds, the luminance will be lowered from 80% to about 60% with about 3 seconds spent.

In this case, as illustrated in FIG. 8C, the lowering of the high-luminance, small white pattern from the 80-% luminance to the 60-% luminance is performed within the time-interval T2 in a curve-like manner such that the former-half portion changes steeply and the latter-half portion changes gradually.

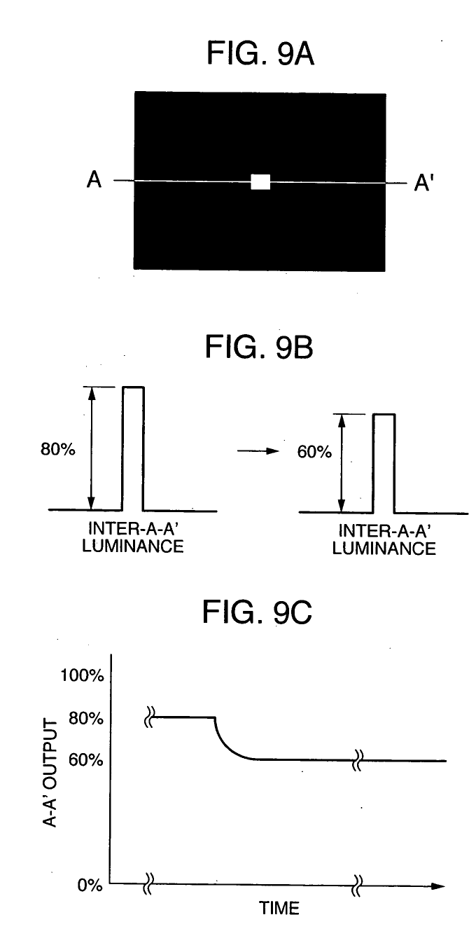

FIG. 9A to FIG. 9C are schematic diagrams for explaining a modified example of the driving method of the organic-EL display device in the present embodiment.

In the driving method illustrated in FIG. 9A to FIG. 9C as well, as illustrated in FIG. 9A, a high-luminance, small white pattern is displayed on a low average-luminance screen (here, black). The driving method illustrated in FIG. 9A to FIG. 9C, however, differs from the above-described driving method illustrated in FIG. 6A to FIG. 6C in a point that, when letting luminance of the black background be 0%, the luminance of the white pattern is set as being 80%.

In the driving method illustrated in FIG. 9A to FIG. 9C as well, as illustrated in FIG. 9B, when the high-luminance, small white pattern is displayed at the same position of the black background, if the display of the high-luminance portion continues to be performed longer than 10 seconds, the luminance will be lowered from 80% to about 60% with about 3 seconds spent.

In the driving method illustrated in FIG. 9A to FIG. 9C, however, the high-luminance portion whose luminance will be lowered to about 60% is displayed using FRC (Frame Rate Control) from luminance of 50% and luminance of 70%.

In this case, as illustrated in FIG. 9C, the lowering of the high-luminance, small white pattern from the 80-% luminance to the 60-% luminance is performed within the time-interval T2 in a curve-like manner such that the former-half portion changes steeply and the latter-half portion changes gradually.

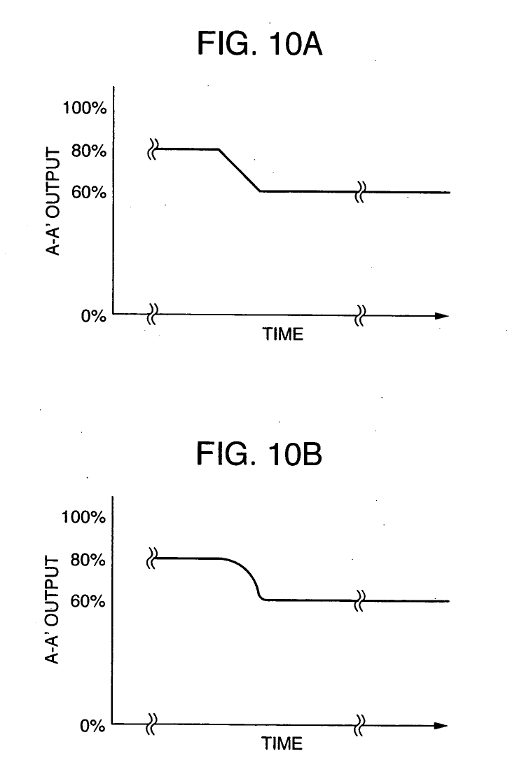

FIG. 10A to FIG. 10B are schematic diagrams for explaining a modified example of the driving method of the organic-EL display in the present embodiment.

In FIG. 8C and FIG. 9C, the lowering of the high-luminance, small white pattern from the 80-% luminance to the 60-% luminance is performed within the time-interval T2 in a curve-like manner such that the former-half portion changes steeply and the latter-half portion changes gradually. In FIG. 10A, however, the lowering of the high-luminance, small white pattern from the 80-% luminance to the 60-% luminance is performed in a straight-line-like manner (i.e., the luminance is decreased uniformly with respect to time).

Also, FIG. 10B illustrates the following configuration: Namely, the lowering of the high-luminance, small white pattern from the 80-% luminance to the 60-% luminance is performed in a curve-like manner which becomes opposite to a curve-like manner illustrated in FIG. 8C and FIG. 9C. This means that the lowering is performed within the time-interval T2 in a curve-like manner such that the former-half portion changes gradually and the latter-half portion changes steeply.

Incidentally, in the driving methods according to the present invention, when letting luminance of black be 0%, luminance of a high-luminance, small white pattern displayed on a low average-luminance screen is designated as W. Moreover, when W satisfies W≧80%, and luminance value lowered with about a time-interval T2 spent is designated as W1, W-W1=20% (e.g., 100%→80%, 80%→60%) is preferable.

Also, when W satisfies 60%<W<80%, it is preferable to lower the luminance of the high-luminance, small white pattern down to 60% with about the time-interval T2 spent.

Also, in the driving methods according to the present invention, when a high-luminance, small white pattern is displayed on a low average-luminance screen for a long time (i.e., a time-interval T1), luminance of the high-luminance, small white pattern will be lowered with about a time-interval T2 spent. Here, when letting luminance of black be 0%, it is preferable to set luminance of the low average-luminance screen as being 50% or lower.

Incidentally, the driving method in the present embodiment is executed by control by the above-described microcomputer & frame memory 120.

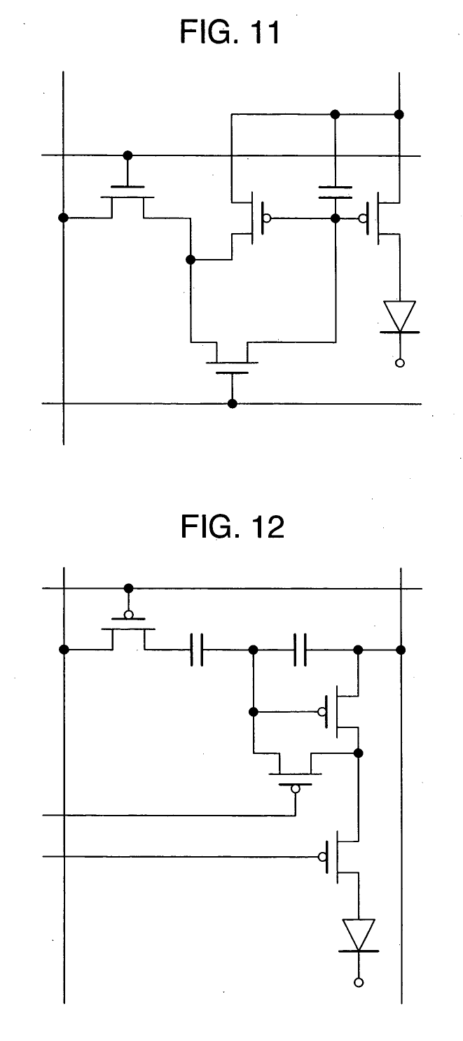

FIG. 11 and FIG. 12 are circuit diagrams for illustrating the other examples of one pixel of the organic-EL display panel 10 illustrated in FIG. 2.

The pixel illustrated in FIG. 2 includes the two transistors, i.e., one switching-use thin film transistor and one driving-use thin film transistor. In contrast thereto, pixels illustrated in FIG. 11 and FIG. 12 differ from the pixel illustrated in FIG. 2 in a point that the pixels include four transistors, i.e., two switching-use thin film transistors and two driving-use thin film transistors.

It is needless to say that the present invention is applicable not only to one pixel of the organic-EL display panel 10 illustrated in FIG. 1, but also to the pixels illustrated in FIG. 11 and FIG. 12.

Incidentally, since the pixels illustrated in FIG. 11 and FIG. 12 have been publicly known from conventionally, the detailed explanation thereof will be omitted.

As having been explained so far, in the present embodiment, it becomes possible to prevent the burn-in of the white-pattern displayed portion without the feeling of a sense of the contrast lack when the small white pattern is displayed at the same position of the black background for a long time.

So far, based on the above-described embodiments, the concrete explanation has been given concerning the invention devised by the present inventors. It is needless to say, however, that the present invention is not limited to the above-described embodiments, but is modifiable in various ways within a scope not departing from its essence and spirit.

An effect acquired by the representative invention of the inventions disclosed in the present application will be briefly explained as follows:

According to the EL display of the present invention and the driving method therefore, it becomes possible to prevent the burn-in of the white-pattern displayed portion without the feeling of a sense of the contrast lack when the small white pattern is displayed at the same position of the black background for a long time.

It should be further understood by those skilled in the art that although the foregoing description has been made on embodiments of the invention, the invention is not limited thereto and various changes and modifications may be made without departing from the spirit of the invention and the scope of the appended claims.

1. An organic-electroluminescence display device, comprising:
an organic-electroluminescence element panel, and
an input-signal processing circuit into which an image signal is to be input,
said input-signal processing circuit comprising
a luminance detection circuit which detects an average luminance of said input image signal, and
a luminance control circuit whereby responsive to the detected average luminance, for when, as an image on said organic-electroluminescence element panel, a high-luminance pattern continues to be displayed longer than a time-interval T1 on a screen of a low average-luminance, lowering the luminance of said pattern down to a predetermined value with a time-interval T2 after T1.

2. The organic-electroluminescence display device according to claim 1, wherein said time-interval T1 is equal to 10 seconds, and a time-interval T2 is equal to 3 seconds.

3. The organic-electroluminescence display device according to claim 1, wherein, when luminance of a black image displayed on said organic-electroluminescence element panel is defined as being 0%, and luminance of a white image displayed on said organic-electroluminescence element panel is defined as being 100%, said average luminance is equal to 50% or lower.

4. The electroluminescence display device according to claim 3, wherein, if said luminance of said pattern displayed longer than said time-interval T1 is equal to 80% or higher, said luminance control circuit lowers said luminance of said pattern down to a value at which a luminance difference between said value and said luminance of said pattern displayed longer than said time-interval T1 becomes equal to 20%.

5. The organic-electroluminescence display device according to claim 3, wherein, if said luminance of said pattern displayed longer than said time-interval T1 falls in a range of 60% to 80%, said luminance control circuit lowers said luminance of said pattern down to 60%.

6. The organic-electroluminescence display device according to claim 1, wherein said luminance control circuit lowers said luminance of said pattern in a straight-line-like manner within said time-interval T2.

7. The organic-electroluminescence display device, wherein said luminance control circuit according to claim 1 functions lower said luminance of said pattern within said time-interval T2 in a curve-like manner such that the former-half portion of T2 changes gradually and the latter-half portion of T2 changes steeply in luminance.

8. The organic-electroluminescence display device according to claim 1, wherein said luminance control circuit functions to lower said luminance of said pattern within said time-interval T2 in a curve-like manner such that the former-half portion of T2 changes steeply and the latter-half portion of T2 changes gradually in luminance.

9. The organic-electroluminescence display device according to claim 1, wherein said luminance of said pattern after a lapse of said time-interval T2 is implemented using FRC scheme.

10. A method of driving an organic-electroluminescence display device including an organic-electroluminescence element panel, said method comprising the steps of:
detecting continuing to display, as an image on said organic-electroluminescence element panel, a high-luminance fixed pattern longer than a time-interval T1 on a low average-luminance screen, and
in response to said detecting, lowering said luminance of said pattern down to a predetermined value with a time-interval T2 after T1.

11. The method according to claim 10, wherein said time-interval T1 is equal to 10 seconds, and said time-interval T2 is equal to 3 seconds.

12. The method according to claim 10, wherein, when luminance of a black image displayed on said organic-electroluminescence element panel is defined as being 0%, and luminance of a white image displayed on said organic-electroluminescence element panel is defined as being 100%, said average luminance is equal to 50% or lower.

13. The method according to claim 12, wherein, if said luminance of said pattern displayed longer than said time-interval T1 is equal to 80% or higher, said predetermined value is a value at which a luminance difference between said value and said luminance of said pattern displayed longer than said time-interval T1 becomes equal to 20%.

14. The method according to claim 12, wherein, if said luminance of said pattern displayed longer than said time-interval T1 falls in a range of 60% to 80%, said predetermined value is equal to 60%.

15. The method according to claim 10, wherein said luminance of said pattern is lowered in a straight-line-like manner within said time-interval T2.

16. The method according to claim 10, wherein said luminance of said fixed pattern is lowered within said time-interval T2 in a curve-like manner such that the former-half portion of T2 changes gradually and the latter-half portion of T2 changes steeply in luminance.

17. The method according to claim 10, wherein said luminance of said pattern is lowered within said time-interval T2 in a curve-like manner such that the former-half portion of T2 changes steeply and the latter-half portion of T2 changes gradually in luminance.

18. The method according to claim 10, wherein said luminance of said pattern after a lapse of said time-interval T2 is implemented using FRC scheme.
